(19) United States
(12) Patent Application Publication
(10) Pub. No.: US 2015/0262142 A1
(43) Pub. Date: Sep. 17, 2015

(54) SETTLEMENT PROCESSING SYSTEM

(71) Applicant: PANASONIC INTELLECTUAL PROPERTY MANAGEMENT CO., LTD., Osaka (JP)

(72) Inventors: Takeshi NINOMIYA, Hyogo (JP); Manabu MATSUMOTO, Fukuoka (JP); Yoshihide NAKASHIMA, Fukuoka (JP)

(73) Assignee: PANASONIC INTELLECTUAL PROPERTY MANAGEMENT CO., LTD., Osaka (JP)

(21) Appl. No.: 14/638,140

(22) Filed: Mar. 4, 2015

(30) Foreign Application Priority Data
Mar. 11, 2014 (JP) 2014-047868

(51) Int. Cl. G06Q 20/08; G06Q 20/34

(52) U.S. Cl. CPC G06Q 20/08; G06Q 20/34

(57) ABSTRACT

Provided is a settlement processing apparatus including a card reader unit that reads predetermined card information recorded in a customer's card, a reception unit that receives information of a predetermined connection destination device conversion table which is transmitted from a statistic information management server that manages sales information (total transactions amount) of a transactions performed on the basis of the use of the card for a predetermined period of time, a determination unit that determines a connection destination device to be connected in settlement of the transaction using the card, by using the connection destination device conversion table, in accordance with the read card information, and a settlement processing unit that performs transmission and reception of a command or data regarding the settlement of the transaction using the card to and from the connection destination device determined by the determination unit.

### BACKGROUND OF THE INVENTION

1. Field of the Invention

The present invention relates to a settlement processing system which is used to perform a credit inquiry of settlement or a sales process in a transaction.

2. Description of the Related Art

For example, in a (credit) transaction of goods or a service using a credit card, the safety (security) of the transaction is secured by verifying whether or not a person performing the transaction is the same person as the owner of the credit card used for the transaction (identity verification). The identity verification is performed by a customer signing a transaction slip, having transaction details printed thereon, during the transaction and by a store clerk visually comparing the signature and a signature written on the credit card.

In recent years, such settlement terminal devices capable of inputting and displaying a signature have been realized using a smartphone or a tablet terminal. A large number of such smartphones or tablet terminals are being distributed for customer use, and thus it is possible to construct the settlement terminal devices by supplying the smartphones or tablet terminals at low prices. That is, if such settlement terminal devices can be configured using a large number of information terminals, such as smartphones or tablet terminals, which are being distributed as devices for customer use, the settlement terminal devices can be supplied at low prices. Since development platforms of applications (software) which are used in a settlement process and other business affairs can be used for various purposes, the reuse and recycling of development assets are facilitated.

In recent years, the types of credit cards used by customers purchasing products in a credit card member store (for example, store; hereinafter, simply referred to as “member store”) which handles a credit card transaction have diversified. As a mechanism capable of supporting a procedure of a settlement process during a customer's product purchase when using any of such a plurality of types of credit card, for example, Japan has a system in which a settlement relay center assigns a credit inquiry to the corresponding credit card issuing company using card information transmitted from a settlement terminal device within a store. However, in such an assignment system, operation costs of the settlement relay center are incurred.

Here, for example, a credit card system disclosed in Japanese Patent Unexamined Publication No. 08-305934 is known as related art in which a connection destination (for example, a credit card issuing company) during a settlement process is switched in a settlement terminal device. The credit card system disclosed in Japanese Patent Unexamined Publication No. 08-305934 determines the availability of a credit card on the basis of management information (for example, expiration date information and credit card limit amount information) which is registered in the credit card at the time of using the credit card. When the credit card system determines that the availability of the credit card should be determined in its own system, the credit card system displays a determination result of the availability of the credit card of its own system. When the credit card system determines that the availability of the credit card should be determined in another system, the credit card system inquires of another system about the availability of the credit card and displays a determination result in another system.

The specification of US Patent Unexamined Publication No. 2011/00202360 discloses a supplier subscription program. In the supplier subscription program, a supplier of which the payment using a predetermined payment processing service is not approved collects acquirers, that is, member stores handling a specific credit card transaction. When a procedure of a settlement process is performed between the supplier and a company that controls sales data based on the credit card transaction of the member store, the supplier inquires of a certain acquirer about payment through a payment processing service and then similarly inquires of another acquirer when the payment is not approved even after a predetermined period of time elapses.

However, in the transaction terminal devices of the related art, there is a problem in that a transaction counterparty (for example, an acquirer or a credit card issuing company) which is necessarily capable of giving a benefit to both the owner of the credit card (customer) and a member store may not be selected. In relation to this problem, for example, when it takes time for a customer to subscribe to a payment processing service performed between the customer and an acquirer in a settlement process using a credit card when the customer purchases a supplier's product, the customer has to continue to wait until the settlement process is completed, and thus there is a problem in that the customer is given an unpleasant impression.

### SUMMARY OF THE INVENTION

In order to solve the above-mentioned problems, the invention provides a settlement processing system that adaptively selects a transaction counterparty which is preferable for both the owner of a credit card and a member store.

According to an aspect of the present invention, there is provided a settlement processing system including a settlement terminal device which is used for settlement of a transaction based on use of a customer's card, and a statistic information management server which manages sales information of the transactions performed for a predetermined period of time. The statistic information management server includes a server side table generation unit which acquires settlement contract information regarding a contract made between a member store related to settlement of a transaction and a settlement center for each member store in which the settlement terminal device is installed, and generates a connection destination device conversion table for determining a connection destination device to be connected in the settlement of the transaction using the card, by using commission rate information based on the sales information of the transactions performed for the predetermined period of time and predetermined customer profit return information which are included in the settlement contract information, and a transmission unit which transmits information of the connection destination device conversion table generated by the server side table generation unit to the settlement terminal device. The settlement terminal device includes a card reader unit which reads predetermined card information recorded in the card, a reception unit which receives the information of the connection destination device conversion table which is transmitted from the statistic information management server, a determination unit which determines a connection destination device to be connected in the settlement of the transaction using the card, by using the connection destination device conversion table, in accordance with the card information read by the card reader unit, and a settlement processing unit that performs transmission and reception of a command or data regarding the settlement of the transaction using the card to and from the connection destination device determined by the determination unit. The statistic information management server updates the connection destination device conversion table on the basis of the acquired settlement contract information, transmits the updated connection destination device conversion table to the settlement terminal device, and updates the connection destination device conversion table within the settlement terminal device.

In this configuration, the statistic information management server generates the connection destination device conversion table for determining the connection destination device to be connected in the settlement of the transaction using the card, by using the predetermined customer profit return information and the commission rate information based on the sales information (total transactions amount) of the transactions performed on the basis of the use of the customer's card for a predetermined period of time, and transmits the connection destination device conversion table to the settlement terminal device. The settlement terminal device determines a connection destination device to be connected in the settlement of the transaction using the card, by using the connection destination device conversion table transmitted from the statistic information management server, in accordance with the card information (for example, information of a card issuing company) which is recorded in the customer's card (for example, a credit card). In this configuration, for example, when information of the connection destination device conversion table is updated by the statistic information management server, the settlement terminal device receives the updated information of the connection destination device conversion table and determines a connection destination device related to a settlement process by using the updated information of the connection destination device conversion table when the settlement terminal device is started (for example, powered on) or restarted. Therefore, according to the present disclosure, it is possible to adaptively select a transaction counterparty which is preferable for both the owner of a credit card and a member store.

### BRIEF DESCRIPTION OF DRAWINGS

FIG. 1A is a block diagram showing a first system configuration example of a settlement processing system according to the present exemplary embodiment;

FIG. 1B is a block diagram showing a second system configuration example of the settlement processing system according to the present exemplary embodiment;

FIG. 2A is a front view showing the exterior of a settlement terminal device according to the present exemplary embodiment;

FIG. 2B is a side view showing the exterior of the settlement terminal device shown in FIG. 2A;

FIG. 3 is a block diagram specifically showing an example of a hardware configuration of the settlement terminal device according to the present exemplary embodiment;

FIG. 4 is a block diagram specifically showing an example of a system configuration mainly having software functions of the settlement terminal device according to the present exemplary embodiment;

FIG. 5 is a block diagram specifically showing an example of a hardware configuration of a statistic information management server according to the present exemplary embodiment;

FIG. 6 is a diagram illustrating an operation outline in a case where a connection destination device of the settlement terminal device according to the present exemplary embodiment is a settlement center;

FIG. 7 is a diagram illustrating an operation outline in a case where the connection destination device of the settlement terminal device according to the present exemplary embodiment is an acquirer;

FIG. 8A is a graph showing an example of a relationship between an annual settlement cumulative amount and a commission rate;

FIG. 8B is a diagram supplementarily illustrating contents of a connection destination acquirer conversion table;

FIG. 9 is a flow chart specifically illustrating a first operation procedure during a settlement process of the settlement terminal device according to the present exemplary embodiment; and

FIG. 10 is a flow chart specifically illustrating a second operation procedure during the settlement process of the settlement terminal device according to the present exemplary embodiment.

### DETAILED DESCRIPTION OF THE PREFERRED EMBODIMENT

Hereinafter, an exemplary embodiment of a settlement processing system, a settlement processing apparatus, and a settlement processing method according to the invention (hereinafter, referred to as “the present exemplary embodiment”) will be described with reference to the accompanying drawings. In the following present exemplary embodiment, a settlement terminal device used during a settlement process in a transaction of a product or a service is illustrated as an example of the settlement processing apparatus constituting a portion of the settlement processing system according to the invention, and a settlement processing system including a settlement terminal device is illustrated as an example of the settlement processing system. The invention is not limited to the settlement processing system, the settlement processing apparatus, and the settlement processing method, and may be realized as a computer-readable recording medium for causing the settlement processing apparatus to perform an operation of the settlement processing method or a program for causing the settlement processing apparatus to perform an operation of the settlement processing method.

System Configuration of Settlement Processing System

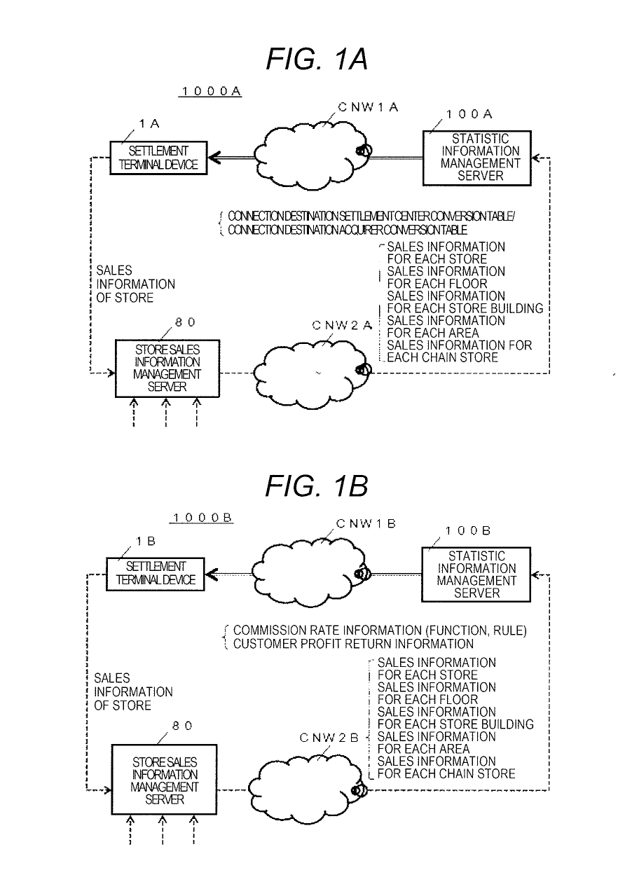

First, a system configuration of settlement processing system 1000 (1000A, 1000B) according to the present exemplary embodiment will be described with reference to FIGS. 1A and 1B. FIG. 1A is a block diagram showing a first system configuration example of settlement processing system 1000A according to the present exemplary embodiment. FIG. 1B is a block diagram showing a second system configuration example of settlement processing system 1000B according to the present exemplary embodiment. In the description of FIG. 1B, a description of the same contents as those in FIG. 1A will be simplified or omitted, and different contents will be described.

Settlement processing system 1000A shown in FIG. 1A is configured to include settlement terminal device 1A, store sales information management server 80, and statistic information management server 100A. Settlement terminal device 1A and statistic information management server 100A are connected to each other through wide area network (for example, WAN) CNW1A. Store sales information management server 80 and statistic information management server 100A are connected to each other through a wide area network (for example, WAN) CNW2A. Settlement terminal device 1A and store sales information management server 80 are connected to each other through a wired or wireless network. Wide area networks CNW1A and CNW2A may be the same network or may be different networks.

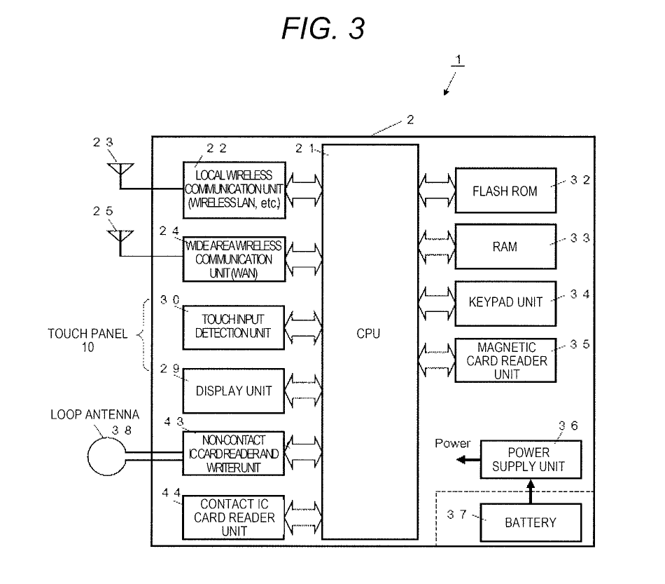

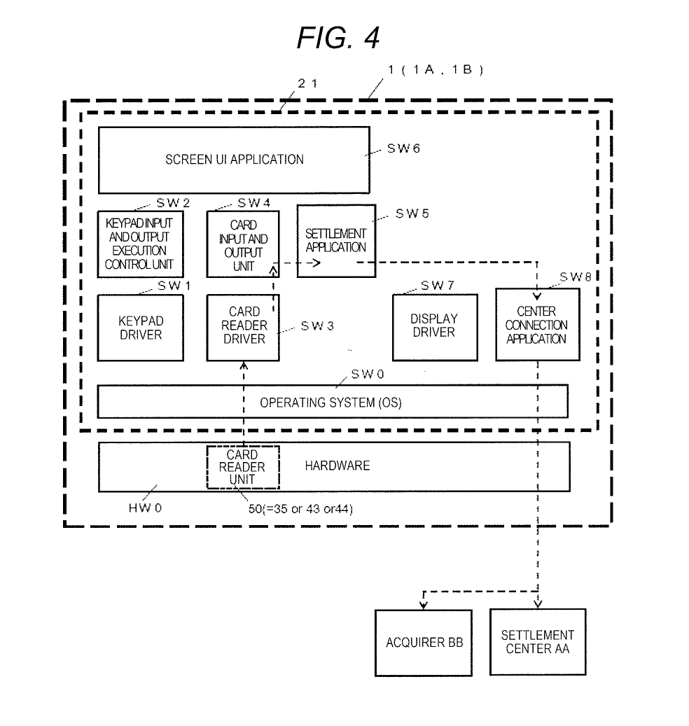

Settlement terminal device 1A is installed in, for example, a member store (for example, a store) and is connected to a settlement center or acquirer to be described later when a settlement process is performed in a transaction based on the use of a customer's card (for example, a credit card). Settlement terminal device 1A receives credit from the settlement center or the acquirer and then transmits sales information in the member store having settlement terminal device 1A installed therein to store sales information management server 80 in addition to the settlement center or the acquirer. Although described later in detail, settlement terminal device 1A receives data of connection destination settlement center conversion table 60 or connection destination acquirer conversion table 60A (see the subsequent description) which is transmitted by statistic information management server 100A. A detailed internal configuration of settlement terminal device 1A will be described later with reference to FIGS. 3 and 4.

Store sales information management server 80 receives pieces of sales information transmitted from a plurality of other settlement terminal devices (not shown) including settlement terminal device 1A, and manages sales information corresponding to, for example, any of each member store, each floor, each store building, each area, and each chain store. Store sales information management server 80 transmits sales information corresponding to any of each member store, each floor, each store building, each area, and each chain store to statistic information management server 100A through network CNW2A.

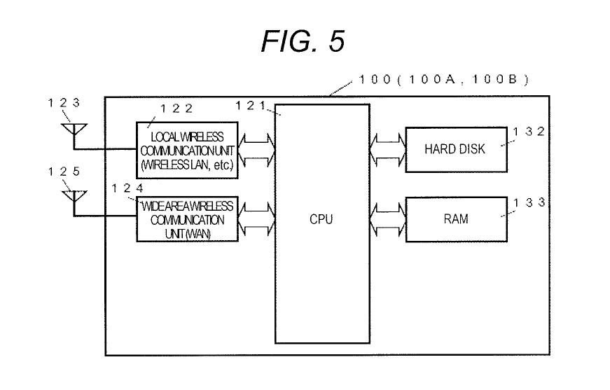

Statistic information management server 100A receives the sales information corresponding to any of each member store, each floor, each store building, each area, and each chain store which is transmitted from store sales information management server 80 and stores the sales information in hard disk 132 (see FIG. 5). Statistic information management server 100A stores information regarding a contract made between a member store related to settlement of a transaction and a settlement center or an acquirer (hereinafter, referred to as “settlement contract information”) for each member store having settlement terminal device 1A installed therein. The settlement contract information includes, for example, information regarding a commission rate (commission rate information) which indicates a proportion of transaction commission paid to a settlement center or an acquirer by a member store in accordance with a total transactions amount for a predetermined period of time (for example, for one year) and customer profit return information regarding end user benefits (for example, cash-back and points provision) which are periodically performed by a member store, in addition to general main matters regarding settlement contracts, but the invention is not limited thereto. Statistic information management server 100A generates connection destination settlement center conversion table 60 or connection destination acquirer conversion table 60A using the commission rate information and the predetermined customer profit return information for each member store and transmits the table to a settlement terminal device (for example, settlement terminal device 1) of the corresponding member store. A detailed internal configuration of statistic information management server 100A will be described with reference to FIG. 5.

Settlement processing system 1000B shown in FIG. 1B is configured to include settlement terminal device 1B, store sales information management server 80, and statistic information management server 100B. Settlement terminal device 1B and statistic information management server 100B are connected to each other through wide area network (for example, WAN) CNW1B. Store sales information management server 80 and statistic information management server 100B are connected to each other through wide area network (for example, WAN) CNW2B. Wide area networks CNW1B and CNW2B may be the same network or may be different networks.

Although described later in detail, in FIG. 1B, settlement terminal device 1B receives commission rate information and customer profit return information which are transmitted by statistic information management server 100B and generates data of connection destination settlement center conversion table 60 or connection destination acquirer conversion table 60A (see the subsequent description).

Statistic information management server 100B reads out commission rate information and predetermined customer profit return information for each member store from hard disk 132 that stores settlement contract information, and transmits the pieces of information to a settlement terminal device (for example, settlement terminal device 1B) of the corresponding member store.

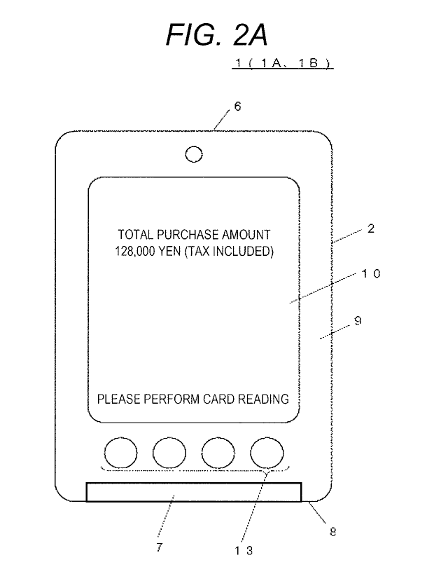

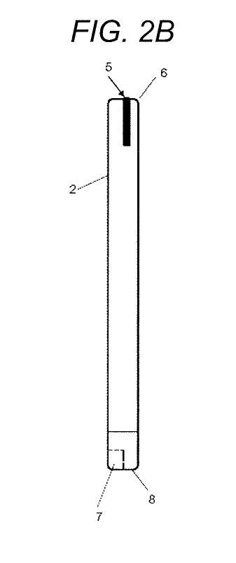

FIG. 2A is a front view showing the exterior of settlement terminal device 1 (1A and 1B are included, the same applies hereinafter) of the present exemplary embodiment. FIG. 2B is a side view showing the exterior of settlement terminal device 1 shown in FIG. 2A. Settlement terminal device 1 of the present exemplary embodiment is a portable type and is configured to include information processing unit 2 that performs various types of processes including, for example, a settlement process in a transaction of goods or a service.

Settlement terminal device 1 shown in FIG. 2A includes slit 5 serving as a path for sliding a magnetic card in upper side surface 6 of information processing unit 2, for example, in order to read card information recorded in the magnetic card. Settlement terminal device 1 includes insertion port 7 into which a contact IC card is inserted in lower side surface 8 of information processing unit 2, for example, in order to read card information recorded in a contact IC card. Settlement terminal device 1 includes loop antenna 38, for example, for reading card information recorded in a non-contact IC card, within settlement terminal device 1.

Settlement terminal device 1 includes touch panel 10 functioning as an example of an input unit and a display unit in front face 9 of information processing unit 2 (see FIG. 2A). Further, settlement terminal device 1 includes input keys 13 outside one side (lower side in the drawing) of touch panel 10 in front face 9.

Hardware Configuration of Settlement Terminal Device

FIG. 3 is a block diagram specifically showing an example of a hardware configuration of settlement terminal device 1 according to the present exemplary embodiment. Settlement terminal device 1 shown in FIG. 3 is configured to include CPU 21, local wireless communication unit 22 connected to local wireless communication antenna 23, wide area wireless communication unit 24 connected to wide area wireless communication antenna 25, display unit 29, touch input detection unit 30, flash ROM 32, RAM 33, keypad unit 34, magnetic card reader unit 35, power supply unit 36, battery 37, non-contact IC card reader and writer unit 43 connected to loop antenna 38, and contact IC card reader unit 44.

Information processing unit 2 of settlement terminal device 1 includes central processing unit (CPU) 21 that controls units of settlement terminal device 1 shown in FIG. 3 as a whole. In FIG. 3, the units of settlement terminal device 1 are connected to CPU 21.

Local wireless communication unit 22 as an example of a reception unit is connected to local wireless communication antenna 23, and performs wireless communication using, for example, wireless local area network (LAN) through a local wireless communication path not shown in the drawing. The local wireless communication is not limited to, for example, a wireless LAN, and may be Bluetooth (Registered Trademark) or the like.

Local wireless communication unit 22 receives pieces of data of connection destination settlement center conversion table 60 and connection destination acquirer conversion table 60A, which are transmitted from statistic information management server 100A, through the above-mentioned local wireless communication path (not shown) and wide area network CNW1A (see FIG. 1A) which is connected to the end thereof, and outputs the pieces of data to CPU 21. Local wireless communication unit 22 receives commission rate information and customer profit return information transmitted from statistic information management server 100B and outputs the pieces of information to CPU 21.

Wide area wireless communication unit 24 as an example of a reception unit is connected to wide area wireless communication antenna 25 and performs wide area wireless communication through a wide area network (WAN) not shown in the drawing. The wide area wireless communication can use mobile communication such as, for example, wideband code division multiple access (W-CDMA), universal mobile telecommunications system (UMTS), code division multiple access (CDMA) 2000, and long term evolution (LTE). Wide area wireless communication unit 24 receives pieces of data of connection destination settlement center conversion table 60 and connection destination acquirer conversion table 60A, which are transmitted from statistic information management server 100A, through the above-mentioned wide area network (not shown) and wide area network CNW1A (see FIG. 1A) which is connected to the end thereof, and outputs the pieces of data to CPU 21. Wide area wireless communication unit 24 receives commission rate information and customer profit return information transmitted from statistic information management server 100B and outputs the pieces of information to CPU 21.

Display unit 29 is constituted by, for example, a liquid crystal display (LCD) or organic electroluminescence (EL) and displays information or data, which is instructed to be displayed by CPU 21, on touch panel 10 shown in FIG. 2A. Touch input detection unit 30 detects a touch input of a user (for example, a store clerk of a member store or a customer purchasing a product) with respect to touch panel 10.

Flash read only memory (ROM) 32 stores various types of data. The stored data may be data regarding business affairs or may be a program for controlling the operation of settlement terminal device 1 (mainly, information processing unit 2). The program includes various types of programs, such as an application (software) for a settlement process, which are related to the operation of settlement terminal device 1. Flash ROM 32 has a function as a recording medium that records a program. Flash ROM 32 stores pieces of data of connection destination settlement center conversion table 60 and connection destination acquirer conversion table 60A. In the present exemplary embodiment, the pieces of data of connection destination settlement center conversion table 60 and connection destination acquirer conversion table 60A may be transmitted from statistic information management server 100A, or may be generated by settlement terminal device 1B.

RAM 33 is a work memory which is used to temporarily store processing data generated in the middle of a computation process or the like associated with the operation of settlement terminal device 1 (mainly, information processing unit 2).

Keypad unit 34 corresponds to input keys 13 shown in FIG. 2A and receives a key input from input keys 13.

Magnetic card reader unit 35 as an example of a card reader unit is disposed within slit 5 shown in FIG. 2B and reads a magnetic stripe as card information printed on a magnetic card. The card information read by magnetic card reader unit 35 is input to CPU 21.

Non-contact IC card reader and writer unit 43 as an example of a card reader unit is connected to loop antenna 38 and reads card information recorded in the non-contact IC card. The card information read by non-contact IC card reader and writer unit 43 is input to CPU 21.

Contact IC card reader unit 44 as an example of a card reader unit is disposed within insertion port 7 shown in FIG. 2A, and reads card information recorded in contact IC card through an electrode of the contact IC card inserted into insertion port 7. The card information read by contact IC card reader unit 44 is input to CPU 21.

Power supply unit 36, which is mainly a power supply of information processing unit 2, receives the supply of power stored in battery 37 and supplies the power to each of units included in information processing unit 2 including CPU 21. CPU 21 can supply power and stop supplying power to some or all of the circuits constituting information processing unit 2 by controlling power supply unit 36. Destinations to be supplied with power from power supply unit 36 include units such as local wireless communication unit 22, wide area wireless communication unit 24, display unit 29, touch input detection unit 30, non-contact IC card reader and writer unit 43, contact IC card reader unit 44, keypad unit 34, and magnetic card reader unit 35, in addition to CPU 21.

Software Configuration of Settlement Terminal Device

FIG. 4 is a block diagram specifically showing an example of a system configuration mainly having software functions of settlement terminal device 1 according to the present exemplary embodiment. In FIG. 4, operations performed in CPU 21 of information processing unit 2 of settlement terminal device 1 are shown as functional blocks of software. Specifically, in FIG. 4, the functions of operating system (OS) SW0, keypad driver SW1, keypad input and output execution control unit SW2, card reader driver SW3, card input and output unit SW4, settlement application SW5, screen user interface (UI) application SW6, display driver SW7, and center connection application SW8 are performed (mounted) in CPU 21, with respect to hardware HWO including card reader units 50 of various types of cards.

Operating system (OS) SW0 is basic software for causing settlement terminal device 1 to operate as a computer and is, for example, Windows (Registered Trademark) or Linux (Registered Trademark).

Keypad driver SW1 controls the operation of input keys 13 (corresponding to keypad unit 34 shown in FIG. 3) shown in FIG. 2A, acquires information or data which is input by input keys 13 shown in FIG. 2A, and outputs the information or data to keypad input and output execution control unit SW2. In the present exemplary embodiment, the information or data which is input by input keys 13 is, for example, settlement money amount information, payment method information (for example, lump-sum payment and the number of times of splitting during split payment) of a credit card, a personal identification number (PIN) of the credit card, and the like when a customer purchases a product using the credit card. The information input by input keys 13 may be only a personal identification number (PIN) of a credit card. In this case, other pieces of information, for example, settlement money amount information and payment method information (for example, lump-sum payment and the number of times of splitting during split payment) of the credit card when a customer purchases a product using the credit card are input by touch panel 10.

Keypad input and output execution control unit SW2 controls the management of information or data which is input using keypad unit 34 shown in FIG. 3 and the execution of operations related to the input and output of the information or data. Keypad input and output execution control unit SW2 acquires information or data which is output from, for example, keypad driver SW1 and outputs the information or data to settlement application SW5 or screen UI application SW6.

Keypad input and output execution control unit SW2 instructs screen UI application SW6 to display a screen which is input by input keys 13 shown in FIG. 2A. Keypad input and output execution control unit SW2 outputs data of characters or an image displayed on display unit 29 to display driver SW7.

Card reader driver SW3 controls the operation of card reader unit 50 (specifically, magnetic card reader unit 35, non-contact IC card reader and writer unit 43, and contact IC card reader unit 44 shown in FIG. 3, the same applies hereinafter), acquires card information (for example, card brand information and customer information including the number of a customer's credit card) which is read by card reader unit 50, and outputs the card information to card input and output unit SW4 (see dotted lines shown in FIG. 4). Card reader driver SW3 may be mounted independently in each of magnetic card reader unit 35, non-contact IC card reader and writer unit 43, and contact IC card reader unit 44.

Card input and output unit SW4 manages the card information read by card reader unit 50 and outputs, for example, card information read by card reader driver SW3 to settlement application SW5.

Settlement application SW5 is an application (software) related to settlement when a customer purchases a product in a member store (for example, a store). Settlement application SW5 is an application which can be used regardless of the types and number of connection destination devices (for example, settlement centers and acquirers) when a customer performs a settlement process at the time of purchasing a product in a member store. For example, settlement application SW5 instructs screen UI application SW6 to display a screen of an application related to the settlement process.

Settlement application SW5 as an example of a terminal side table generation unit generates data of connection destination settlement center conversion table 60 or connection destination acquirer conversion table 60A (see the subsequent description) using commission rate information and customer profit return information which are transmitted by statistic information management server 100B.

Settlement application SW5 as an example of a determination unit determines a settlement center or acquirer corresponding to card information which is output from card input and output unit SW4 with reference to connection destination settlement center conversion table 60 or connection destination acquirer conversion table 60A which is transmitted from statistic information management server 100 or connection destination settlement center conversion table 60 or connection destination acquirer conversion table 60A which is generated by settlement application SW5, in accordance with the information or data (specifically, card information) which is output from card input and output unit SW4, when performing a settlement process.

Settlement application SW5 instructs center connection application SW8 to connect and communicate with an external connection destination device (specifically, settlement center AA or acquirer BB to be described later) which is determined by settlement application SW5, using information or data output from keypad input and output execution control unit SW2 and information or data output from card input and output unit SW4, when performing a settlement process.

Screen UI application SW6 controls a display of a screen (specifically, a screen for a store clerk of a member store to perform an input during a settlement process) which is displayed on touch panel 10 shown in FIG. 2A and controls the management of information or data which is input on the screen, in accordance with the instruction from settlement application SW5.

Screen UI application SW6 controls a display of a screen which is input by input keys 13 shown in FIG. 2A and the management of information or data which is input on the screen, in accordance with the instruction from keypad input and output execution control unit SW2. Screen UI application SW6 outputs data of characters or an image displayed on display unit 29 to display driver SW7.

Display driver SW7 controls the operation of display unit 29 shown in FIG. 3, acquires, for example, data of a settlement screen output from keypad input and output execution control unit SW2 or settlement application SW5 or data of characters or an image output from screen UI application SW6, and displays the settlement screen or the characters or image on display unit 29.

Center connection application SW8 as an example of a settlement processing unit performs the transmission and reception of a command or data regarding a settlement process, more specifically, the transmission of an encrypted PIN, the transmission of a credit inquiry and card information required for the credit inquiry, the reception of a result of the credit inquiry, the transmission of sales processing data, or the like to and from an external connection destination device (for example, settlement center AA and acquirer BB) which is determined by settlement application SW5 through local wireless communication unit 22 or wide area wireless communication unit 24.

Settlement terminal device 1 including the above-mentioned configuration has the following characteristics.

In the present exemplary embodiment, information processing unit 2 includes touch panel 10 (see FIG. 2A and FIG. 3) which is constituted by display unit 29 and touch input detection unit 30, and local wireless communication unit 22 or wide area wireless communication unit 24 which is capable of communicating with an external connection destination device (for example, settlement center AA).

In recent years, settlement schemes of a transaction using a card have diversified by a contact IC card, a non-contact IC card, and electronic money being added to a magnetic card which has been used hitherto for settlement of a transaction using a card. In association with the addition of new settlement schemes, the development cost and price of settlement terminal device 1 are increasing. Here, if a large number of such information processing units 2 are information processing terminals, such as a smartphone and a tablet terminal, which are being distributed for customer use, settlement terminal device 1 can be supplied at a low price. Thus, an increase in the development cost of settlement terminal device 1 is minimized.

In this case, a general-purpose OS (see, for example, operating system SW0 shown in FIG. 4) is adopted as a software platform in information processing unit 2. Therefore, since development platforms of an application for settlement (settlement application) and applications used for other business affairs (hereinafter, “business affair applications”) are used for various purposes, the reuse and recycling of development assets are facilitated. If a device for customer use can be used for the configuration of information processing unit 2, information processing unit 2 has such a high computation ability that the recording and reproducing of a video can be performed without stress. Therefore, it is possible to flexibly execute the settlement application and the business affair applications without stress.

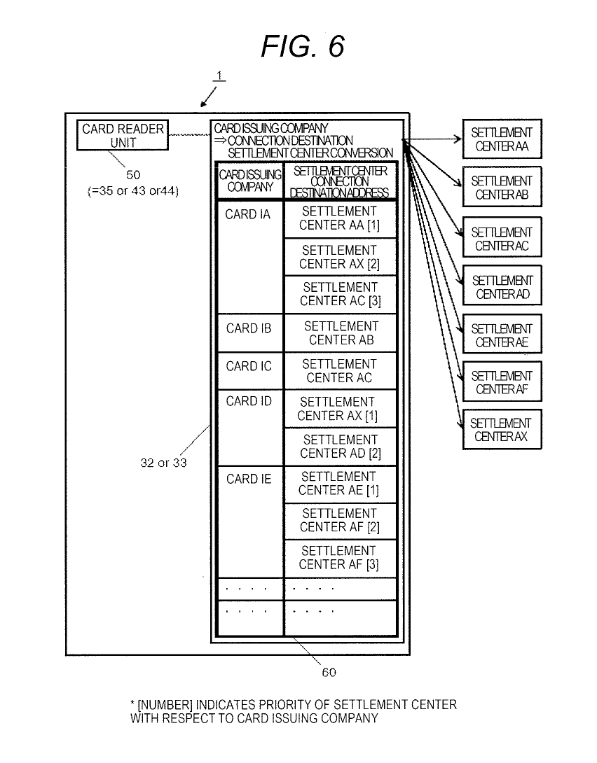

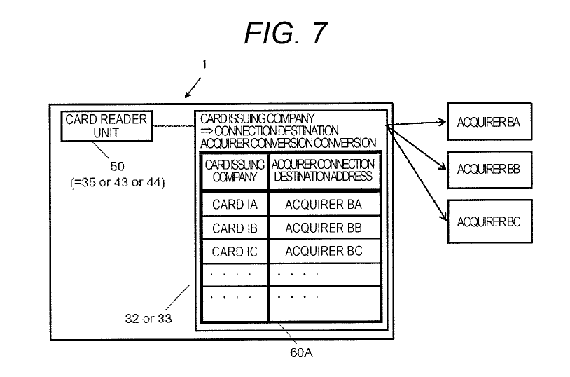

In the present exemplary embodiment, during a settlement process of a transaction in which settlement application SW5 shown in FIG. 4 is being activated, settlement terminal device 1 adaptively selects an external connection destination device related to the settlement process in accordance with card information of a customer's credit card (see FIG. 6 or FIG. 7).

Configuration of Statistic Information Management Server

Next, configurations of statistic information management servers 100A and 100B according to the present exemplary embodiment will be described with reference to FIG. 5. FIG. 5 is a block diagram specifically showing an example of a hardware configuration of statistic information management server 100 (100A, 100B) according to the present exemplary embodiment. The configurations of statistic information management servers 100A and 100B are the same, and thus a description of statistic information management server 100 will be given below.

Statistic information management server 100 (100A and 100B are included, the same applies hereinafter) shown in FIG. 5 is configured to include CPU 121, local wireless communication unit 122 connected to local wireless communication antenna 123, wide area wireless communication unit 124 connected to wide area wireless communication antenna 125, hard disk 132, and RAM 133.

CPU 121 controls the overall operations of units of statistic information management server 100 and performs a process of storing information or data in hard disk 132, a process for performing an input and an output to each unit, and other control processes. CPU 121 as an example of a server side table generation unit generates connection destination settlement center conversion table 60 and connection destination acquirer conversion table 60A for determining a connection destination device (for example, a settlement center or an acquirer) to be connected thereto in order to perform a settlement process of a transaction using a card, using commission rate information based on sales information (total transactions amount) for each member store based on the use of a customer's card and predetermined customer profit return information. CPU 121 transmits pieces of data of connection destination settlement center conversion table 60 and connection destination acquirer conversion table 60A to settlement terminal device 1 from local wireless communication unit 122 or wide area wireless communication unit 124.

Local wireless communication unit 122 as an example of a transmission unit is connected to local wireless communication antenna 123 and performs wireless communication using, for example, a wireless LAN through a local wireless communication path not shown in the drawing. Local wireless communication unit 122 transmits the pieces of data of connection destination settlement center conversion table 60 and connection destination acquirer conversion table 60A which are output from CPU 121 to settlement terminal device 1 through the above-mentioned local wireless communication path (not shown) and wide area network CNW1A (see FIG. 1A) which is connected to the end thereof from local wireless communication antenna 123. Alternatively, local wireless communication unit 122 transmits commission rate information and customer profit return information which are output from CPU 121 to settlement terminal device 1 from local wireless communication antenna 123.

Wide area wireless communication unit 124 as an example of a transmission unit is connected to wide area wireless communication antenna 125 and performs wide area wireless communication through a wide area network (for example, a WAN) not shown in the drawing. Wide area wireless communication unit 124 transmits the pieces of data of connection destination settlement center conversion table 60 and connection destination acquirer conversion table 60A which are output from CPU 121 to settlement terminal device 1 from wide area wireless communication antenna 125. Alternatively, wide area wireless communication unit 124 transmits the commission rate information and customer profit return information which are output from CPU 121 to settlement terminal device 1 from the above-mentioned wide area network (not shown) and wide area network CNW1A (see FIG. 1A) which is connected to the end thereof from wide area wireless communication antenna 125.

Hard disk 132 as an example of a storage unit stores various types of data. The stored data is information regarding a contract made between a member store related to settlement of a transaction and a settlement center or an acquirer (settlement contract information), for example, for each member store in which settlement terminal device 1A is installed. The settlement contract information includes commission rate information indicating a proportion of commission paid to a settlement center or an acquirer by a member store in accordance with a total transactions amount for a predetermined period of time (for example, for one year) and customer profit return information regarding end user benefits (for example, cash-back and points provision) of campaigns which are periodically performed by a member store. In statistic information management server 100 shown in FIG. 5, a flash memory may be used instead of hard disk 132.

RAM 133 is a work memory which is used to temporarily store processing data generated in the middle of a computation process or the like associated with the operation of statistic information management server 100.

Selection of Settlement Center as Connection Destination Device

Next, the selection of a settlement center as a connection destination device to be connected when settlement terminal device 1 according to the present exemplary embodiment performs a settlement process of a transaction will be described with reference to FIG. 6. FIG. 6 is a diagram illustrating an operation outline in a case where a connection destination device of settlement terminal device 1 according to the present exemplary embodiment is a settlement center.

In FIG. 6, settlement center AA, settlement center AB, settlement center AC, settlement center AD, settlement center AE, settlement center AF, and settlement center AX are shown as connection destinations when a settlement process is performed in a member store in which settlement terminal device 1 is installed. In other words, the member store in which settlement terminal device 1 shown in FIG. 6 is installed makes a contract with settlement center AA, settlement center AB, settlement center AC, settlement center AD, settlement center AE, settlement center AF, and settlement center AX with regard to settlement of a transaction using a credit card.

In FIG. 6, settlement terminal device 1 stores connection destination settlement center conversion table 60 transmitted from statistic information management server 100 or connection destination settlement center conversion table 60 generated on the basis of commission rate information and customer profit return information transmitted from statistic information management server 100, for example, in flash ROM 32. Connection destination settlement center conversion table 60 is a table in which identification information of a settlement center to be connected when a member store performs a settlement process is determined in advance in accordance with the type of card issuing company (also referred to as “issuer”) of a credit card to be subjected to a transaction. The identification information of the settlement center is, for example, a uniform resource locator (URL) of the settlement center, an internet protocol (IP) address of the settlement center, any of an IP address and a port number of the settlement center, or a combination of the plurality of pieces of information.

In connection destination settlement center conversion table 60, a plurality of settlement centers may be registered as connection destinations when performing a settlement process with respect to a card issuing company of one credit card. When a plurality of settlement centers are registered as connection destinations when performing a settlement process, priority information regarding the connection destinations is also determined.

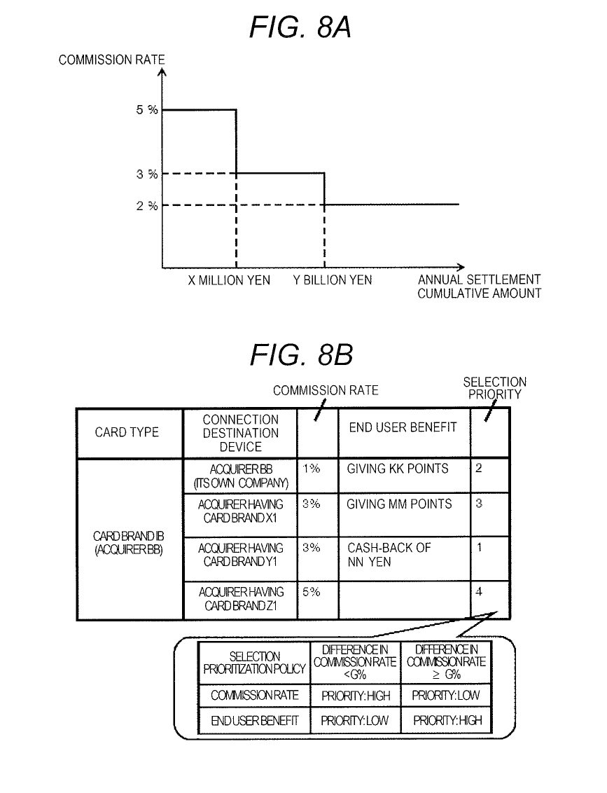

For example, as shown in FIG. 6, when the card issuing company is card IA, the priority regarding the connection destination at the time of performing a settlement process is determined in the member store in the order of settlement center AA, settlement center AX, and settlement center AC. Such priority information is determined independently by a member store on the basis of a policy regarding a priority which is determined in advance by the member store (see FIG. 8B to be described later, for example, a policy created in consideration of information regarding a commission rate (proportion of settlement commission with respect to a settlement money amount) which is paid to a settlement center and information regarding a benefit given to a customer (customer profit return information such as a return campaign performed by an acquirer or details of the points returned to a customer) depending on a customer's card use amount). The priority information is not limited to being independently determined by the member store, and may be determined on the basis of a contract made between the member store and the acquirer.

In this manner, when a plurality of settlement centers are registered for each card issuing company, priority information for each settlement center is also registered. Therefore, settlement terminal device 1 can adaptively select a settlement center capable of giving benefits to both a customer purchasing a product using a credit card and a member store.

The benefits given to a customer purchasing a product using a credit card means, for example, a cash-back campaign of cash being returned to the customer when the customer purchases a product priced at more than a predetermined price in a predetermined period of time or point privileges given for each credit card. The benefit given to a member store means that, for example, a member store performs a transaction using its own credit card when the member store issues its own credit card (for example, when an acquirer is present in an organization of a company group of the member store) and thus can perform the transaction using a low or free commission rate of its own credit card without paying a transaction commission based on a high commission rate required when using a credit card issued by another company. Therefore, it is possible to minimize a decrease in an operating profit which leads to an increase in sales opportunities due to point privileges with less burden on the member store.

In FIG. 6, for the purpose of simplifying the description, a contact IC card (for example, a credit card) has been illustrated as a card used for settlement of a transaction. However, card reader unit 50 of settlement terminal device 1 shown in FIG. 6 may be any of magnetic card reader unit 35, non-contact IC card reader and writer unit 43, and contact IC card reader unit 44, and this is the same as in FIG. 7. Further, connection destination settlement center conversion table 60 has been described as being stored in flash ROM 32 in advance. However, for example, when settlement terminal device 1 receives data of connection destination settlement center conversion table 60 from statistic information management server 100, the table may be temporarily stored in RAM 33, and this is the same as in connection destination acquirer conversion table 60A shown in FIG. 7.

Selection of Acquirer as Connection Destination Device

Next, the selection of an acquirer as a connection destination device to be connected when settlement terminal device 1 according to the present exemplary embodiment performs a settlement process of a transaction will be described with reference to FIG. 7. FIG. 7 is a diagram illustrating an operation outline in a case where a connection destination device of settlement terminal device 1 according to the present exemplary embodiment is an acquirer. In the description of FIG. 7, a description of the same contents as those in FIG. 6 will be omitted or simplified, and different contents will be described.

In FIG. 7, acquirer BA, acquirer BB, and acquirer BC are shown as connection destinations of settlement terminal device 1. In other words, a member store having settlement terminal device 1, shown in FIG. 7, being installed therein is under contract to acquirer BA, acquirer BB, and acquirer BC with regard to settlement of a transaction using a credit card.

In FIG. 7, settlement terminal device 1 stores connection destination acquirer conversion table 60A transmitted from statistic information management server 100 or connection destination acquirer conversion table 60A generated on the basis of commission rate information and customer profit return information transmitted from statistic information management server 100, for example, in flash ROM 32. Connection destination acquirer conversion table 60A is a table in which identification information of an acquirer to be connected when a member store performs a settlement process is determined in advance in accordance with the type of card issuing company (issuer) of a credit card to be subjected to a transaction. The identification information of the acquirer is, for example, a uniform resource locator (URL) of the acquirer, an internet protocol (IP) address of the acquirer, any of an IP address and a port number of the acquirer, or a combination of a plurality of pieces of information.

Although not shown in FIG. 7, in connection destination acquirer conversion table 60A, a plurality of acquirers may be registered as connection destinations when performing a settlement process with respect to a card issuing company of one credit card. When a plurality of acquirers are registered as connection destinations when performing a settlement process, priority information regarding the connection destinations may also be determined, similar to FIG. 6.

When the plurality of acquirers are registered for each card issuing company, priority information for each acquirer is also registered. Therefore, settlement terminal device 1 can adaptively select a settlement center capable of giving benefits to both a customer purchasing a product using a credit card and a member store. The benefits are the same as the above-mentioned benefits, and thus a description thereof will be omitted.

Commission Rate Information and Customer Profit Return Information

Next, details of commission rate information and customer profit return information will be described with reference to FIGS. 8A and 8B. FIG. 8A is a graph showing an example of a relationship between an annual settlement cumulative amount and a commission rate. FIG. 8B is a diagram supplementarily illustrating contents of connection destination acquirer conversion table 60A.

FIG. 8A illustrates a relationship showing an example of a commission rate based on a contract made between a certain member store and an acquirer. Specifically, when an annual settlement cumulative amount (total transactions amount) of the member store is less than X million yen, a commission rate of 5% is imposed. When the annual settlement cumulative amount is equal to or greater than X million yen and less than Y billion yen, a commission rate of 3% is imposed. When the annual settlement cumulative amount is equal to or greater than Y billion yen, a commission rate of 2% is imposed. In this manner, commission rate information indicating a relationship between the annual settlement cumulative amount and the commission rate is determined, for example, on the basis of a stepwise relationship (function) shown in FIG. 8A. Such commission rate information is stored in hard disk 132 of statistic information management server 100.

In order to describe the contents of connection destination acquirer conversion table 60A shown in FIG. 7, FIG. 8B shows card types (for example, card brand IB), connection destination devices, commission rates, end user benefits, and selection priorities of a card issuing company, for example, in a case where acquirer BB is selected as a connection destination device. FIG. 8B shows that the selection priority is selected, for example, on the basis of a policy including a commission rate and an end user benefit of a member store.

Specifically, in a record of a first row shown in FIG. 8B, a connection destination device is acquirer BB (its own company, that is, the same group company as the member store). When the member store uses acquirer BB at the time of performing settlement of a transaction using a card having card brand IB, the transaction is a transaction handling a credit card of its own company, and thus a commission rate borne by the member store is 1%. The acquirer or the member store gives KK points as customer profit return information (end user benefit) in a case where card brand IB is used.

In a record of a second row shown in FIG. 8B, a connection destination device is an acquirer having card brand X1. A commission rate borne by the member store is 3% with respect to the acquirer. The acquirer or the member store gives MM points as customer profit return information (end user benefit) in a case where the acquirer is used, at the time of performing settlement of a transaction using the card of card brand IB.

In a record of a third row shown in FIG. 8B, a connection destination device is an acquirer having card brand Y1. A commission rate borne by the member store is 3% with respect to the acquirer. The acquirer or the member store performs cash-back of NN yen as customer profit return information (end user benefit) in a case where the acquirer is used, at the time of performing settlement of a transaction using the card of card brand IB.

Finally, in a record of a fourth row shown in FIG. 8B, a connection destination device is an acquirer having card brand Z1. A commission rate borne by the member store is 5% with respect to the acquirer. The acquirer or the member store does not set customer profit return information (end user benefit) in a case where the acquirer is used, at the time of performing settlement of a transaction using the card of card brand IB.

As a policy in a case where a selection priority is determined, as shown in FIG. 8B, for example, the member store determines the selection priority by giving priority to a commission rate over an end user benefit when a commission rate borne by the member store is less than G %, and determines the selection priority by giving priority to an end user benefit over a commission rate when the commission rate is equal to or higher than G %. In other words, the pieces of priority information shown in FIGS. 6, 7, and 8B are determined by the member store, for example, on the basis of the selection prioritization policy shown in FIG. 8B.

Operation Procedure During Settlement Process of Settlement Terminal Device 1

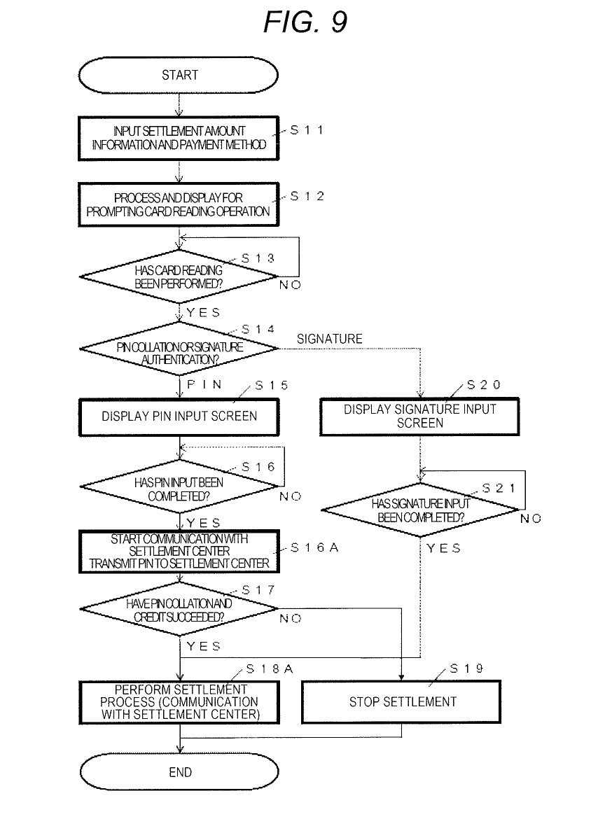

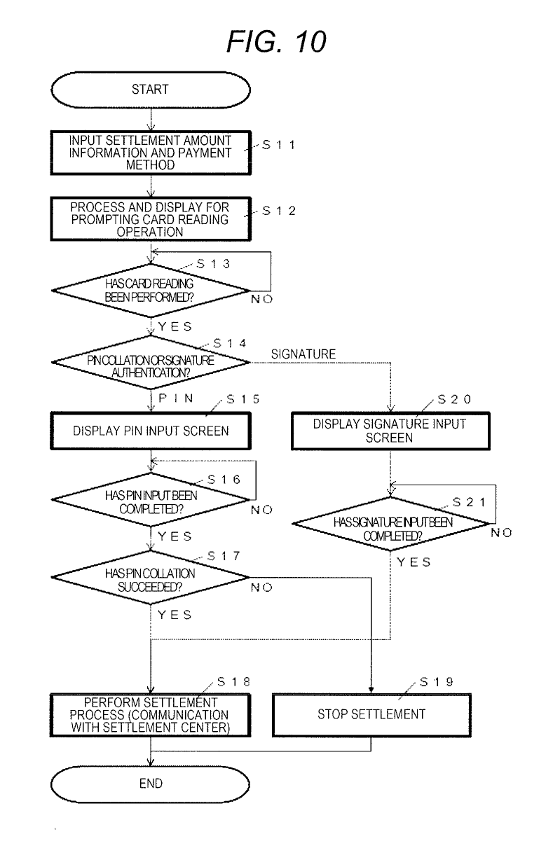

Next, an operation during a settlement process of settlement terminal device 1 according to the present exemplary embodiment will be described with reference to FIGS. 9 and 10. FIG. 9 is a flow chart specifically illustrating a first operation procedure during a settlement process of settlement terminal device 1 according to the present exemplary embodiment. FIG. 10 is a flow chart specifically illustrating a second operation procedure during a settlement process of settlement terminal device 1 according to the present exemplary embodiment. In FIG. 10, a description of the same contents as those in FIG. 9 will be simplified or omitted, and different contents will be described.

Settlement terminal device 1 starts a procedure of a settlement process by executing settlement application SW5 (see FIG. 4) which is installed in information processing unit 2 (see FIG. 2A and FIG. 3).

In FIG. 9 or FIG. 10, settlement terminal device 1 receives an input of information regarding settlement such as information regarding a money amount spent by a customer purchasing a product using a credit card, a method of paying the money amount, and information regarding a card brand of the credit card used for the settlement (S11). The information regarding settlement is input to settlement application SW5, for example, by making a store clerk of a member store press input keys 13 shown in FIG. 2A.

When settlement terminal device 1 receives the information regarding settlement, the settlement terminal device performs a process of prompting a reading operation of a credit card used for the settlement and a display for prompting the reading operation of the credit card, for example, as shown in FIG. 2A (S12). The process of prompting the reading operation of the credit card used for the settlement and the display for prompting the reading operation of the credit card are performed until it is confirmed that the reading operation of the card has been performed (NO in S13).

When it is confirmed that the reading operation of the credit card has been performed (YES in S13), settlement terminal device 1 proceeds to a process of authenticating the credit card. A method of authenticating the credit card is determined on the basis of the type and information of the credit card used for the settlement and a contract made in advance between a member store using settlement terminal device 1 and a settlement center or an acquirer.

For example, when a method of authenticating the credit card is performed using a PIN (PIN in S14), settlement terminal device 1 performs a display of a screen capable of inputting a PIN on touch panel 10 of information processing unit 2 (S15), and waits until a PIN input performed by the owner of the credit card is completed (NO in S16).

When it is confirmed that the PIN input has been completed (YES in S16), settlement terminal device 1 waits for a result of collation regarding whether or not the input PIN coincides with a PIN registered in advance in a settlement center or acquirer as a connection destination device determined in accordance with card information (for example, the card issuing company of the credit card) which is recorded in the credit card read in step S13.

For example, in the first operation procedure shown in FIG. 9, the collation between the PINs is performed in the settlement center. Settlement terminal device 1 encrypts the PIN which is input in step S16 and transmits the encrypted PIN to the settlement center or the acquirer together with card information (S16A).

The settlement center or the acquirer decrypts the PIN received from settlement terminal device 1 and collates the decrypted PIN with a PIN which is managed in the settlement center or the acquirer. When it is confirmed that the two PINs coincide with each other and the card having the card information transmitted together with the PIN has no problem in performing a transaction (for example, the card is not blacklisted) (YES in S17), the settlement center or the acquirer provides credit to settlement terminal device 1. Settlement terminal device 1 receives credit from the settlement center or the acquirer and performs a sales process as the subsequent settlement process (S18), and then terminates the communication with the settlement center. Settlement terminal device 1 may transmit data of the sales process to the settlement center immediately after the sales process is completed and before the communication with the settlement center or the acquirer is terminated, or may transmit the data later along with sales processing data of another settlement. When the two PINs coincide with each other (NO in S17), the settlement center or the acquirer gives notice that credit to settlement terminal device 1 cannot be performed. Settlement terminal device 1 receives the notice from the settlement center or the acquirer and does not perform a sales process, and then the settlement is stopped (S19).

On the other hand, in the second operation procedure shown in FIG. 10, the collation between the PINs is performed between settlement terminal device 1 and a credit card (not shown) which is read to settlement terminal device 1. When the collation result showing that the PIN input in step S16 coincides with a PIN which is recorded in advance in a chip (not shown) within the credit card is obtained (YES in S17), settlement terminal device 1 performs a sales process as the subsequent settlement process (S18). Settlement terminal device 1 may transmit the data of the sales process to the settlement center immediately after the sales process is completed and before the communication with the settlement center or the acquirer is terminated, or may transmit the data later along with sales processing data of another settlement. When a collation result showing that the two PINs do not coincide with each other is obtained (NO in S17), the sales process in settlement terminal device 1 is stopped, and the settlement is stopped (S19).

Also in either of FIGS. 9 and 10, when the method of authenticating the credit card is performed using a signature (signature in S14), settlement terminal device 1 performs a display of a screen capable of inputting a signature on touch panel 10 of information processing unit 2 (S20), and waits until the signature input performed by the owner of the credit card is completed (NO in S21).

When it is confirmed that the signature input has been completed (YES in S21), settlement terminal device 1 performs the subsequent settlement procedure, similar to a case where the collation result showing that the PINs coincide with each other is obtained (S18).

When the method of authenticating the credit card is performed using a signature in step S14 (signature in S14), settlement terminal device 1 first performs a credit inquiry of the settlement. When the settlement terminal device receives notice that the credit inquiry has succeeded, the settlement terminal device may perform a sales process and then display a screen capable of inputting a signature.

As described above, in settlement processing system 1000 (1000A and 1000B are included, the same applies hereinafter) according to the present exemplary embodiment, for example, when settlement terminal device 1 reads a credit card through an operation of a store clerk of a member store in a settlement process in a case where a customer purchases a product using the credit card, the settlement terminal device selects a settlement center or an acquirer as a connection destination at the time of performing the settlement process with reference to connection destination settlement center conversion table 60 or connection destination acquirer conversion table 60A in accordance with card information (for example, a card issuing company) which is registered in the credit card.

Thereby, in settlement processing system 1000, settlement terminal device 1 can adaptively select a connection destination device capable of giving benefits to, for example, both a customer who is the owner of the credit card and a member store.

For example, in Japan, to which settlement center the member store should be connected when performing a settlement process is entrusted to a settlement relay service company that relays a member store and a settlement center. The settlement relay service company determines from which settlement center an encrypted PIN, a credit inquiry, or a sales process transmitted from the member store should be requested. In this manner, when the relay and assignment of the encrypted PIN, the credit inquiry, or the sales process are entrusted to the settlement relay service company, the burden of the entrustment expenses thereof is required of the member store, and thus the member store has a disadvantage.

Therefore, according to settlement processing system 1000 of the present exemplary embodiment, settlement terminal device 1 can effectively select a settlement center as a connection destination at the time of performing a settlement process in accordance with card information (for example, a card issuing company) which is registered in a credit card, and thus it is possible to reduce operation costs spent on the entrustment of a settlement relay service company which is necessary for a member store.

On the other hand, for example, in the United States, a member store has to prepare a dedicated settlement terminal device for each acquirer when performing a settlement process. For this reason, it is considered that there is a problem in that the number of dedicated terminals having to be provided in a member store is increased not only at present when the types of credit card are diversified but also will be in the future.

However, according to settlement processing system 1000 of the present exemplary embodiment, settlement terminal device 1 can effectively select an acquirer as a connection destination at the time of performing a settlement process in accordance with card information (for example, a card issuing company) which is registered in a credit card, and thus a member store is not required to provide a dedicated settlement terminal device for each type of credit card.

At present, a contract to the effect that an exchange of settlement is performed using a dedicated settlement terminal device is made between many member stores and acquirers, but it is assumed that a settlement process may be performed using one settlement terminal device by the use of a settlement application for each acquirer without using a dedicated settlement terminal. In this case, it is necessary to install a settlement application for each acquirer contracting with a member store and to make the settlement application executable, which results in the deterioration of user (store clerk of a member store) operability such as the start or termination of the settlement application whenever a credit card used for settlement is changed.

However, according to settlement processing system 1000 of the present exemplary embodiment, since settlement application SW5 of settlement terminal device 1 is an application which can be used regardless of the types and number of settlement centers or acquirers, settlement terminal device 1 is not required to start another settlement application even when a credit card used for settlement is changed. Thus, it is possible to promptly perform a settlement process without making a customer wait for a long period of time.

In the present exemplary embodiment, when the contents of connection destination settlement center conversion table 60 or connection destination acquirer conversion table 60A are updated, statistic information management server 100 transmits the updated data of connection destination settlement center conversion table 60 or connection destination acquirer conversion table 60A to settlement terminal device 1. Settlement terminal device 1 updates data of connection destination settlement center conversion table 60 or connection destination acquirer conversion table 60A to the updated data of connection destination settlement center conversion table 60 or connection destination acquirer conversion table 60A which is transmitted from statistic information management server 100 during the startup (for example, power on) or restart of settlement terminal device 1. Thereby, settlement terminal device 1 can adaptively select a settlement center or acquirer capable of giving benefits to both a customer who is the owner of a card (for example, a credit card) and a member store, as a connection destination at the time of performing a settlement process, by using the updated connection destination settlement center conversion table 60 or connection destination acquirer conversion table 60A during the settlement process.

In the present exemplary embodiment, when the contents of commission rate information or customer profit return information or the contents of commission rate information and customer profit return information are updated, statistic information management server 100 transmits the updated commission rate information or customer profit return information or the updated commission rate information and customer profit return information to settlement terminal device 1. Settlement terminal device 1 updates commission rate information or customer profit return information or commission rate information and customer profit return information to the updated commission rate information or customer profit return information or the updated commission rate information and customer profit return information which are transmitted from statistic information management server 100 during the startup (for example, power on) or restart of settlement terminal device 1. Thereby, settlement terminal device 1 can generate connection destination settlement center conversion table 60 or connection destination acquirer conversion table 60A by using the updated commission rate information or customer profit return information or the updated commission rate information or customer profit return information during a settlement process, and can adaptively select a settlement center or acquirer capable of giving benefits to both a customer who is the owner of a card (for example, a credit card) and a member store, as a connection destination at the time of performing a settlement process.

Although various exemplary embodiments have been described with reference to the accompanying drawings, the invention is not limited thereto. It is apparent for those skilled in the technical field to which the invention belongs that various modified examples or corrected examples are conceivable within the scope of the technical idea recited in the claims, and it is understood that these fall within the technical scope of the invention.

What is claimed is:

1. A settlement processing system comprising:
a settlement terminal device which is used for settlement of a transaction based on use of a customer's card; and
a statistic information management server which manages sales information of the transactions performed for a predetermined period of time,
wherein the statistic information management server includes
a server side table generation unit which acquires settlement contract information regarding a contract made between a member store related to settlement of a transaction and a settlement center for each member store in which the settlement terminal device is installed, and generates a connection destination device conversion table for determining a connection destination device to be connected in the settlement of the transaction using the card, by using commission rate information based on the sales information of the transactions performed for the predetermined period of time and predetermined customer profit return information which are included in the settlement contract information, and
a transmission unit which transmits information of the connection destination device conversion table generated by the server side table generation unit to the settlement terminal device,
wherein the settlement terminal device includes
a card reader unit which reads predetermined card information recorded in the card,
a reception unit which receives the information of the connection destination device conversion table which is transmitted from the statistic information management server,
a determination unit which determines a connection destination device to be connected in the settlement of the transaction using the card, by using the connection destination device conversion table, in accordance with the card information read by the card reader unit, and
a settlement processing unit that performs transmission and reception of a command or data regarding the settlement of the transaction using the card to and from the connection destination device determined by the determination unit, and
wherein the statistic information management server updates the connection destination device conversion table on the basis of the acquired settlement contract information, transmits the updated connection destination device conversion table to the settlement terminal device, and updates the connection destination device conversion table within the settlement terminal device.

2. The settlement processing system of claim 1,
wherein the connection destination device conversion table determines identification numbers of a plurality of connection destination devices and priority information of the plurality of connection destination devices with respect to a portion or all of the card information, and
wherein the determination unit determines a connection destination device to be connected in settlement of a transaction using a card corresponding to a portion or all of the card information on the basis of the priority information of the plurality of connection destination devices.
